(19) United States
(12) Patent Application Publication
(10) Pub. No.: US 2025/0102018 A1
(43) Pub. Date: Mar. 27, 2025

(54) CONTINUOUS VELOCITY JOINT HAVING DISCONNECT ARRANGEMENT

(71) Applicant: JTEKT Bearings North America LLC, Greenville, SC (US)

(72) Inventors: Anthony Copper, Fountain Inn, SC (US); Mark Brandolin, Greenville, SC (US); Maximilian Frantz, Greenville, SC (US)

(21) Appl. No.: 18/898,223

(22) Filed: Sep. 26, 2024

Related U.S. Application Data
(60) Provisional application No. 63/540,840, filed on Sep. 27, 2023.
(60) Provisional application No. 63/541,134, filed on Sep. 28, 2023.

(51) Int. Cl. F16D 3/10; B60K 23/08

(52) U.S. Cl. CPC F16D 3/10; B60K 23/08; B60K 2023/0858

(57) ABSTRACT

A continuous velocity joint assembly comprising a rotatable input and a rotatable output. A continuous velocity mechanism that allows transfer of power between the input and the output while allowing angular variation is also provided. A disconnect arrangement has first and second portions capable of relative rotation with respect to one another in a disconnected state and incapable of relative rotation with respect to one another in a connected state. An electromechanical actuator causes the disconnect arrangement to shift between the disconnected state and the connected state, whereby the power is transferred between the input and the output in the connected state and power is not transferred between the input and the output in the disconnected state.

### CROSS-REFERENCE TO RELATED APPLICATIONS

This application is based upon and claims priority to U.S. provisional application Ser. No. 63/540,840, filed Sep. 27, 2023, and entitled “Continuous Velocity Joint Having Disconnect Capability,” and U.S. provisional application Ser. No. 63/541,134, filed Sep. 28, 2023, and entitled “Continuous Velocity Joint Disconnect With Flanged Interface.” Both of the aforementioned applications are incorporated fully herein by reference for all purposes.

### FIELD OF THE INVENTION

The present invention relates generally to drivetrains of vehicles and, more particularly, to wheel-end disconnect assemblies for engaging and disengaging the wheels thereof.

### BACKGROUND OF THE INVENTION

Mechanisms for selectively engaging and disengaging drive axles from the wheels of a corresponding vehicle are known. For example, basic concepts may include mechanisms in which multiple drive axles are utilized in the drivetrain on a continuous, or full-time, basis. For various reasons, drivetrains in which drive axles may be engaged and disengaged as necessary, or as desired, have grown in popularity in recent years. For example, known mechanisms allow a user to engage manually a vehicle's drivetrain to the wheels, which typically require the user to exit the vehicle to accomplish the manual engagement. In addition, automated systems are known in which a vehicle's control system automatically engages and disengages the drivetrain from the wheels dependent upon the driving conditions. Such mechanisms, however, often include numerous, intricate components and may, therefore, be complicated and costly to manufacture, as well as to maintain.

The present invention recognizes and addresses considerations of prior art constructions and methods.

### SUMMARY OF THE INVENTION

One aspect of the present invention provides a continuous velocity joint assembly comprising a rotatable input and a rotatable output. A continuous velocity mechanism that allows transfer of power between the input and the output while allowing angular variation is also provided. A disconnect arrangement has first and second portions capable of relative rotation with respect to one another in a disconnected state and incapable of relative rotation with respect to one another in a connected state. An electromechanical actuator causes the disconnect arrangement to shift between the disconnected state and the connected state, whereby the power is transferred between the input and the output in the connected state and power is not transferred between the input and the output in the disconnected state.

According to some exemplary embodiments, the electromechanical actuator may comprise a screw-type actuator such as a lead screw actuator having a lead screw rotatably driven by an electric motor.

According to some exemplary embodiments, a state-maintaining mechanism may be provided which is operative to maintain the disconnect arrangement in at least one of the connected state and the disconnected state if power to the actuator is lost. The state-maintaining mechanism may comprise an energy storage element operative to move the disconnect arrangement to a selected one of the connected state and the disconnected state if power to the actuator is lost. For example, the energy storage element may comprise a torsion spring (e.g., a clock spring) to rotate the lead screw via stored energy. In such embodiments, the state-maintaining mechanism may be configured to provide a selectable preload to the torsion spring. In some embodiments, a detent arrangement may be provided to maintain the disconnect arrangement in another one of the connected state and the disconnected state if power to the actuator is lost.

In some exemplary embodiments, the first portion of the disconnect arrangement may comprise an outer housing in which a shaft carrying multiple trunnions is received. The second portion of the disconnect arrangement may be located axially adjacent to the outer housing, the disconnect arrangement further comprising a clutching mechanism that selectively connects the first and second portions together in the connected state and disconnects the first and second portions in the disconnected state. Furthermore, the clutching mechanism may comprise a shiftable collar having splines defined on its inner circumference, at least one of the first portion and the second portion having splines on an outer circumference slidably engaged by the splines of the shiftable collar. The shiftable collar in such embodiments may define an annular groove about its outer circumference engaged by a fork such that the collar can rotate with respect to the fork, but shifting movement of the fork moves the collar axially.

In some exemplary embodiments, the first portion of the disconnect assembly may comprise an annular member attached to a rotatable housing in which a shaft carrying a plurality of trunnions is received. The annular member may have a plurality of radial projections spaced apart about its periphery, each of the radial projections defining an axial through-bore in which an elongate fastener is received.

According to another aspect, the present invention provides a disconnect arrangement for use with a continuous velocity joint. The arrangement comprises first and second portions capable of relative rotation with respect to one another in a disconnected state and incapable of relative rotation with respect to one another in a connected state. The first portion is configured to be secured to an outer housing of the continuous velocity joint. The second portion is configured to be connected to a source of rotational power. An actuator that causes the disconnect assembly to shift between the disconnected state and the connected state is also provided. As a result, power is transferred between the second portion and the first portion in the connected state and power is not transferred between the second portion and the first portion in the disconnected state.

In some exemplary embodiments, the first portion is configured to be secured to a flange of the outer housing of the continuous velocity joint. The first portion may, for example, define a plurality of angular spaced projections defining respective axial through bores to facilitate securement of the first portion to the flange of the continuous velocity joint.

The accompanying drawings, which are incorporated in and constitute a part of this specification, illustrate one or more embodiments of the disclosure and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which;

FIG. 1 is a diagrammatic representation of a half shaft assembly in accordance with the prior art;

FIG. 2 is an enlarged view of the one of the continuous velocity joints (CVJs) of the half shaft assembly of FIG. 1;

FIG. 3 is a diagrammatic view of a CVJ having disconnect capability according to an embodiment of the present invention;

FIG. 4 is a view of the embodiment of FIG. 3 further showing an actuator for axially moving the CVJ between connected and disconnected states;

FIGS. 5 and 6 show the embodiment of FIG. 3 in disconnected and connected states, respectively;

FIG. 7 is an isometric view of a CVJ having disconnect capability in accordance with an embodiment of the present invention;

FIG. 8 is a cross-sectional view of the CVJ of FIG. 7 showing certain internal components;

FIG. 9 is an enlarged partially exploded view of a portion of the actuator housing of the CVJ of FIG. 7;

FIGS. 10A, 10B, and 10C show components of the actuator used to achieve a monostable or bistable system;

FIGS. 11A and 11B show a disconnect function map showing aspects of the operation of the CVJ of FIG. 7;

FIGS. 12A and 12B show a connect function map showing aspects of the operation of the CVJ of FIG. 7;

FIG. 13 is a cross-sectional view showing aspects of the actuator used to achieve a bistable system;

FIGS. 13A and 13B show components of the actuator of FIG. 13;

FIG. 14 is an isometric view of a disconnect assembly for a CVJ having a flanged interface; and

FIG. 15 is an exploded view of the disconnect assembly of FIG. 14 showing various components thereof.

Repeat use of reference characters in the present specification and drawings is intended to represent same or analogous features or elements of the invention according to the disclosure.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

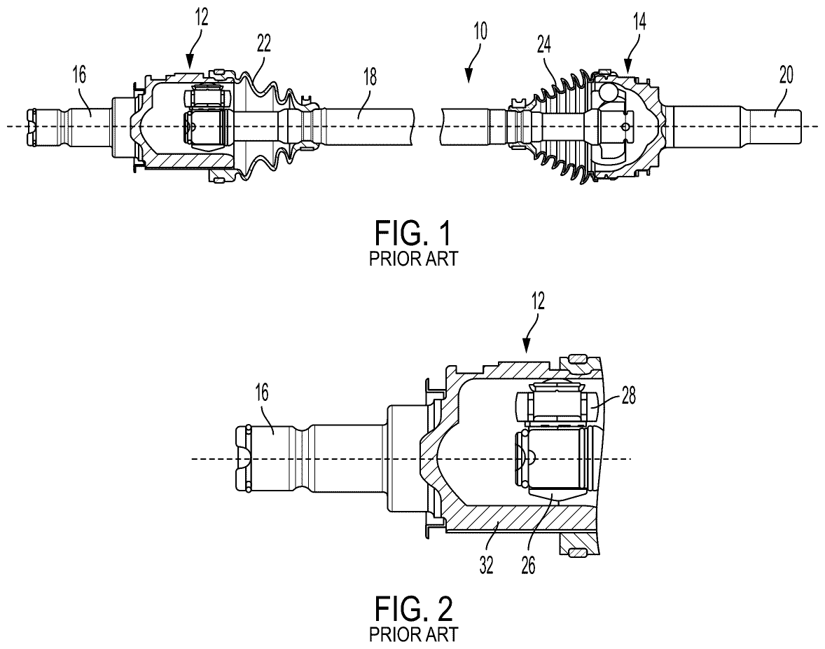

By way of background, FIG. 1 illustrates a prior art vehicle half shaft assembly 10 that may be modified in accordance with principles of the present invention. Half shaft 10 includes first and second continuous velocity joints (CVJs) 12 and 14 near its respective ends. As is well-known, CVJs (also referred to as “constant velocity joints”) function to translate rotation from an input shaft to an output shaft as the angle between the shafts varies within a range. In this case, CVJ 12 is considered the “inboard” CVJ because it is connected directly to a differential such as via stub shaft 16. CVJ 12 transfers torque to an intermediate axle shaft 18, which serves as the input to CVJ 14. CVJ 14 is considered the “outboard CVJ” because it is connected to the wheel to be driven, such as via output stub shaft 20. CVJs 12 and 14 have respective boots 22 and 24 extending between their outer housing (or simply “outer”) and shaft 18 to allow angular movement while containing lubricant and protecting the interior of the CVJs from environmental contaminants.

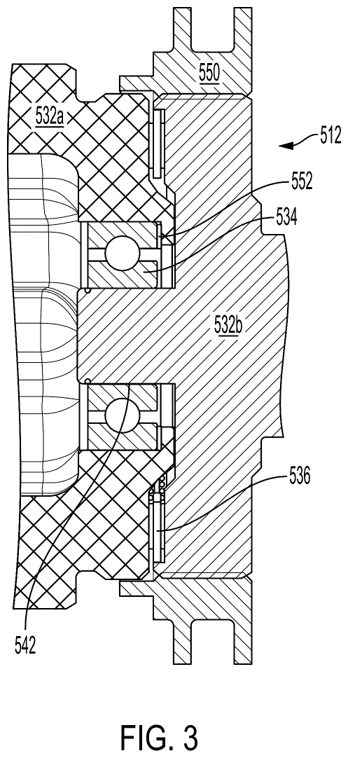

Referring now to FIG. 2, the inboard CVJ 12 is typically constructed as a “plunging CVJ,” meaning that it accommodates some axial movement relative to the axle shaft 18. Plunging CVJs have a “tripod” 26 splined to axle shaft 18 having three trunnions (such as the one shown at 28) extending radially and spaced apart by 120°. Each of the trunnions carries a respective barrel shaped roller bearing that interacts with the CVJ outer 32. Shaft 16 extends from outer 32, as shown. Accordingly, rotation of shaft 16 rotates outer 32, causing rotation of tripod 26 and thus axle shaft 18. The outboard CVJ may also be a tripod CVJ or any other suitable type but will not typically be plunging.

Embodiments of the present invention provide selective interruption of power flow through a CVJ (which could be either a plunging or non-plunging CVJ). This joint could be a stand-alone CVJ or a CVJ that is integrated into a half-shaft. (An example of an application of a stand-alone CVJ might be a prop shaft.) Some embodiments of the present invention achieve selective disconnection of power through the CVJ utilizing a two-piece outer where both pieces can independently rotate around the same axis when disconnected or rotate together when connected.

The point of separation between the two pieces of the CVJ outer could be in a number of different locations, some examples of which are shown in the drawing figures to be discussed below. To selectively transmit power between the two, a clutching mechanism is provided. For example, the two pieces could be selectively coupled utilizing:
A translating ring radially splined to one side and selectively axially splined to the other.
A translating ring radially splined to one side and selectively radially splined to the other.
Radially movable flippers that are always in contact with one side and selectively in contact with the other.
Any other suitable clutching mechanism as necessary or desired.

A suitable actuator is utilized to move the translating or radially movable components, such as:
Motor, rack and pinion, and fork.
Motor, lead screw, and fork.
Motor, half screw, and fork.
Plunger type solenoid and fork.
Annular solenoid and annular armature.

In the case of a solenoid, a bistable solenoid may preferably be used. The solenoid could be made bistable utilizing, for example, a permanent magnet latching system with spring or a retractable pen type mechanism. These bistable options have the benefit of “failing to state” when power is lost to the actuator. A retractable pen mechanism may also work with a motor-based actuator.

A lead screw actuator mechanism traditionally produces either a naturally stable or a naturally unstable assembly with respect to maintaining position of the nut when no power is applied to the motor. In this regard, if the screw is designed to be back-drivable, it will not necessarily hold nut position in a given state (e.g., connected, disconnected, or in between). If the screw is designed to be non-back-drivable, friction in the lead screw allows the nut to hold position in any state (e.g., connected, disconnected, or in between).

In the case of a disconnect assembly for a drive system, monostable or bistable systems are generally preferable to a constantly stable system. For a monostable system, it is sometimes desirable to have a system that will default back to a known state in the event of a loss of control or loss of power to the actuator motor. This type of system uses continuous power to hold the actuator in one of the two desired states. No power is required to hold it in the other state. For a bistable system, it is sometimes desirable to have a system that will hold the connected state or the disconnected state if power is lost to the actuator motor but will transition to a known state in the event of a loss of control or loss of power to the actuator motor when the actuator is in-between connected and disconnected. The benefit of this type of system is that no power is required to hold the actuator in either of the desired states. Certain embodiments of the present enable functionality to ensure the system always “rests” in a connected state if the power is removed from the actuator motor.

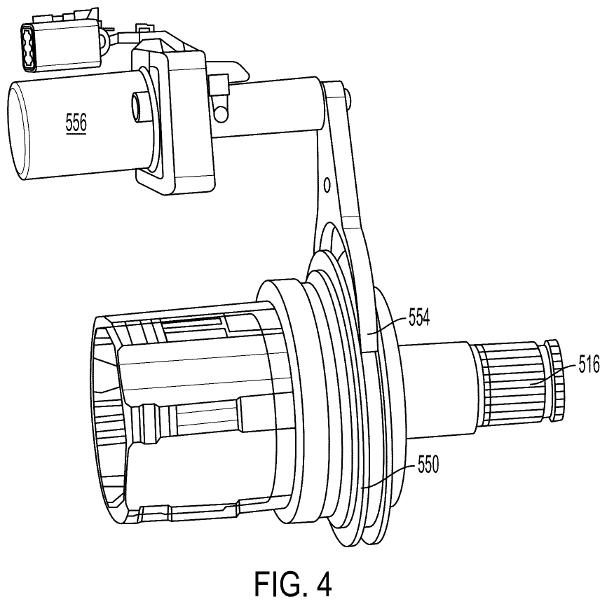

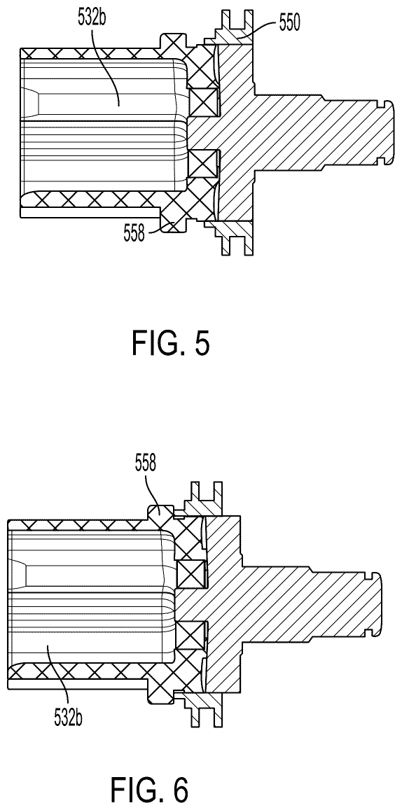

FIGS. 3 and 4 illustrate a CVJ 512 that may utilize aspects of the present invention. CVJ 512 is in this case incorporated into a half shaft assembly having a stub shaft 516 for connection to a source of motive power (e.g., a differential or an e-drive unit). CVJ 512 has a housing (“outer”) that has a first portion 532a in which a tripod is located and a second portion 532b to which stub shaft 516 is fixed. One skilled in the art will appreciate that a boot extends between first portion 532a to an axle shaft that extends from the tripod. As shown, a collar 550 with axial splines on its inner diameter is located on the outer diameter of second portion 532b having complementary splines.

A ball bearing 534 is located on an extension 542 of second portion 532b. In addition, a thrust bearing 536 may be located between axially opposed faces of portions 532a and 532b. A wave spring 552 removes any clearance in the assembly that could cause noise from the thrust bearing or ball bearing in the disconnected state.

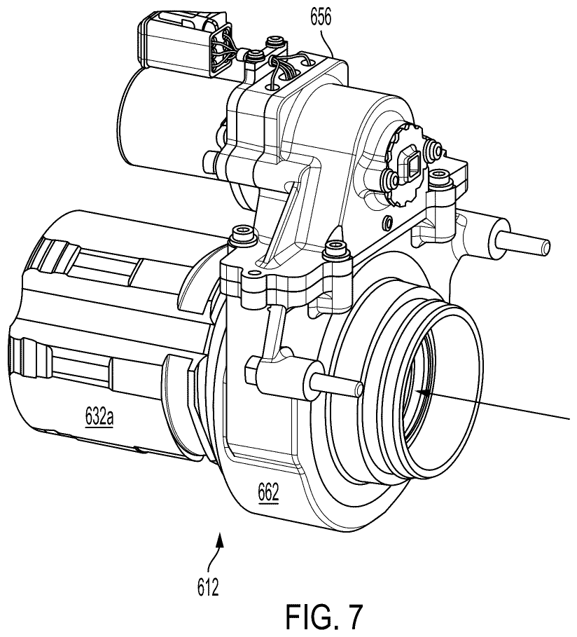

As shown in FIG. 4, collar 550 is shifted between disconnected and connected positions (FIGS. 5 and 6, respectively) in this embodiment using a fork 554 which is moved axially by a suitable linear actuator 556, such as a screw-type actuator (e.g., a lead screw actuator). As can be seen, the fork is received in an annular groove extending about the outer circumference of collar 550 such that the collar 550 can rotate with respect to the fork but the fork can move the collar axially. Collar 550 may, for example, include axial dogs or the like to mate with suitable openings on a flange 558 of first portion 532a.

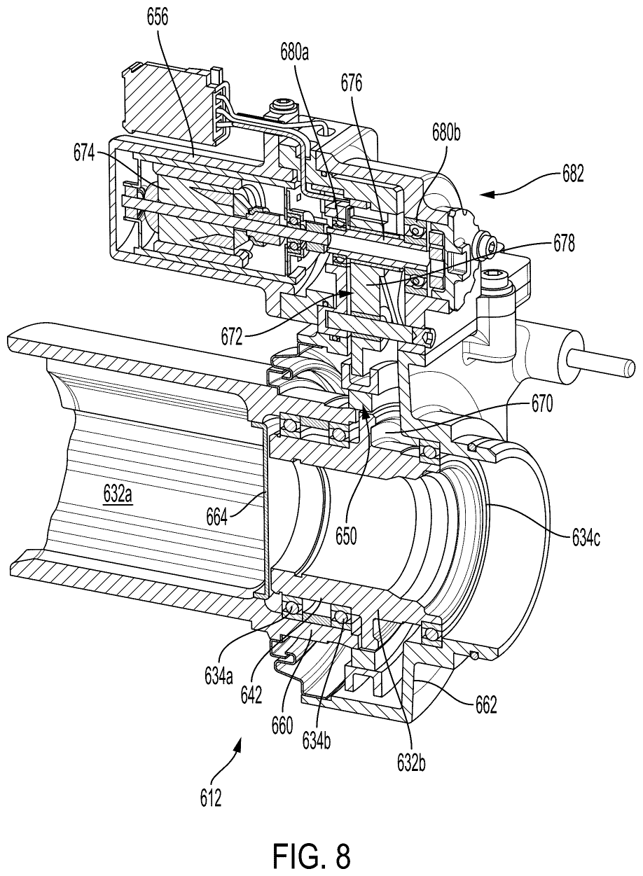

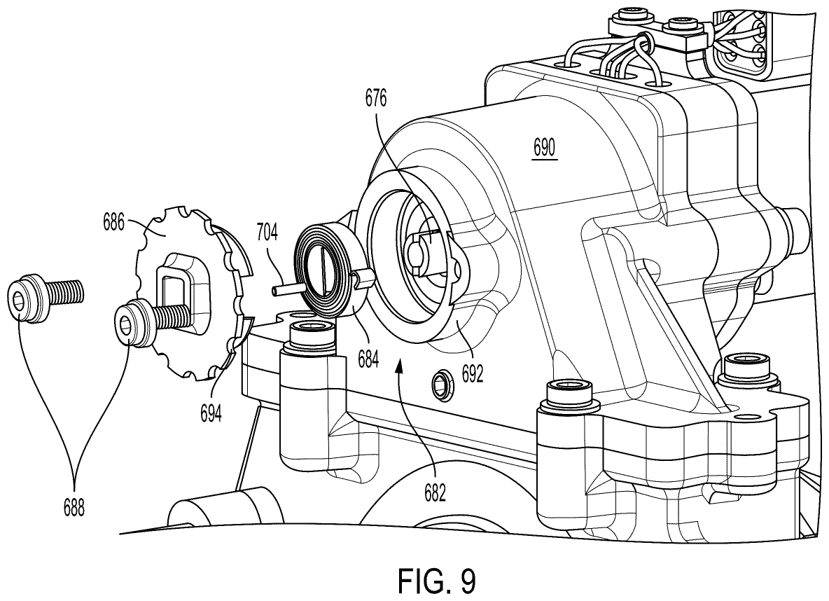

FIGS. 7 and 8 illustrate a CVJ 612 similar in many respects to CVJ 512. As shown, the CVJ housing (“outer”) has a first portion 632a in which the tripod is received. A second portion 632b is configured to rotate with or rotate independently of portion 632a depending on whether CVJ 612 is in a connected or disconnected state. In this case, second portion 632b is configured as a hub to receive, for example, the stub shaft of a differential or e-drive unit. As shown, portion 632a has an annular extension 660 that is located coaxial to an extension 642 of second portion 632b. A pair of ball bearings 634a and 634b are located in the radial space between extensions 642 and 660. An additional ball bearing 634c may be located between an inward extension of second portion 632b and an environmental housing 662 of the CVJ 612. First portion 632a carries a drum-like wall 664 to separate the region where the tripod is located from second portion 632b.

Second portion 632b further has a radial flange 670 having a series of axial splines on its outer circumference. Disconnect collar 650 has splines on its inner circumference engaged with the outer splines of flange 670. An actuator 656, here in the form of a lead screw actuator, moves a fork 672 axially. Fork 672 engages an annular slot of collar 650 so as to shift collar 650 between connected and disconnected positions. In the connected position, collar 650 engages both of first portion 632a and 632b causing them to rotate together (i.e., there is no relative rotation). In the disconnected position, collar 650 is retracted from second portion 632b. First portion 632a can thus rotate at wheel speed independent of rotation of second portion 632b.

Actuator 656 includes a motor 674 that rotates a lead screw 676. Disconnect fork 672 includes an integral nut portion 678 that moves axially as the lead screw 676 is rotated. The direction of rotation determines whether the nut portion 678 (and the disconnect fork 672 of which it is a part) moves in forward or reverse directions. Lead screw 676 is supported for rotation by ball bearings 680a-b, as shown.

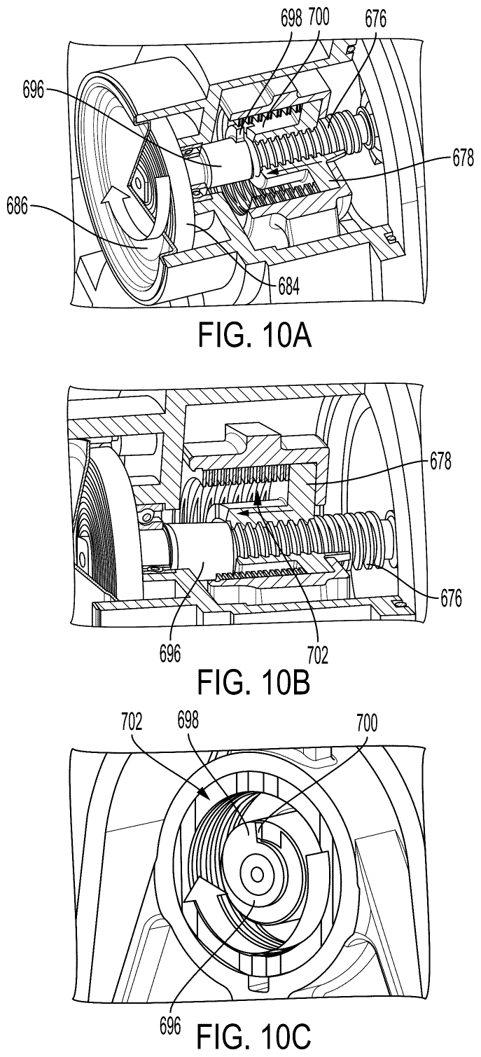

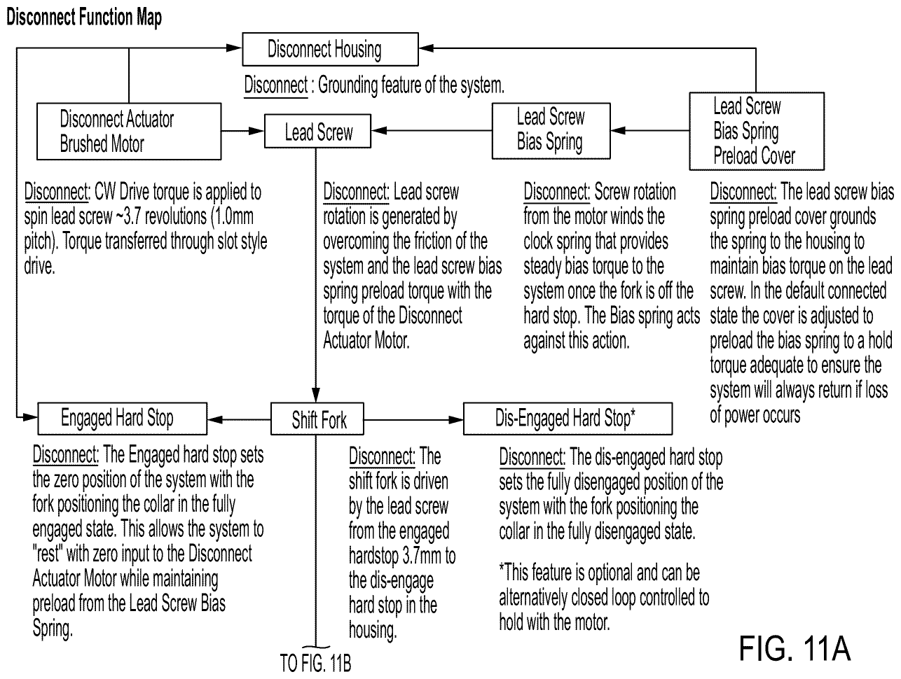

Referring now also to FIGS. 9 and 10, embodiments of the present invention provide functionality to ensure the system always “rests” in a connected state (and/or in a disconnected state) if the power is removed from the actuator motor 674. In this regard, a mechanism 682 is provided to urge the system to a connected state (and/or in a disconnected state) upon the loss of motor power. Mechanism 682 includes a suitable spring that is preferably preloaded to a selected torque required to hold the mechanism in the bias state (e.g., the connected state). In this embodiment, the spring comprises a suitable torsion spring 684. As shown, a “clock spring” may be utilized for this purpose because such springs provide the desired functionality with minimal axial length. In the actuated (disconnected) state, spring 684 is wound from rotations of the lead screw 676 during actuation, thus increasing the torque feedback on the system. The actuation motor 674 must maintain power to resist the potential energy stored in the spring 684 to return the system back to the connected state. (While the description herein describes default to the connected state, one skilled in the art will appreciate that, alternatively, the orientation of the clock spring may be reversed in order to maintain the system in a disconnected state upon power failure.)

As can be most easily explained with reference to FIG. 9, mechanism 682 is configured to allow a user to select the preload. In this embodiment, mechanism 682 includes a cover 686 that is configured to engage spring 684 to preload the spring 684 as the cover 686 is rotated. (The cover thus serves as a “crank” or “dial” for the preload.) Once the desired preload torque is achieved, bolts 688 are threaded into corresponding holes in actuator cover 690 to set the spring in this preload condition. It can be seen that cover 690 defines a boss 692 in which spring 684 is received so as to be in engagement with the lead screw 676 (or more precisely, an adapter that is an extended part of the lead screw in this embodiment). Cover 686 closes the open end of boss 692. As shown, cover 686 includes a series of angularly spaced indentations 694 defining the preload increments. The bolts 688 are respectively located beside a selected one of diametrically opposed pair of the indentations 694.

Referring now to FIGS. 10A-C, an angular hard stop may be integrated into the mechanism 682 to prevent any instance of the system inadvertently becoming locked in the connected state unable to drive the lead screw 676 to disconnect. In this case, an adapter 696 including a stop feature 698 is positioned on the end of lead screw 676 so as to be an integral extension of lead screw 676. Nut portion 678 itself includes a stop feature 700 that is engaged by stop feature 698 when nut portion 678 has reached the desired limit of its outward axial travel. Preferably, stop features 698 and 700 will engage angularly before the main body of nut portion 678 axially contacts adapter 696. A suitable spring arrangement such as a stack 702 of Belleville springs compress as the nut portion moves axially outward so as to allow the nut to travel axially under conditions where collar engagement is not intended, where delta rpm exceeds the application requirements.

In accordance with a preferred embodiment, the mechanism 682 may be assembled as follows: (1) the lead screw 676 is rotated manually or with the actuator motor 674 counterclockwise until the system is fully actuated to the engaged state and the nut portion 678 is stopped by the stop feature 698 of the lead screw. (2) The spring 684 and cover 686 are preassembled with a dowel pin 704 (FIG. 9) to fix the rotation of the outer coil of the spring 684 to the cover 686. (3) The cover/spring subassembly is then inserted into the boss 692 and rotated counterclockwise while monitoring the torque to drive the rotation until the desired preload in the spring is achieved. (4) After reaching the desired preload torque, the rotation is held with the indentations 694 of the cover 686 aligned to the bolt holes in the boss 692 and the cover 686 is secured at this angular position by the bolts 688.

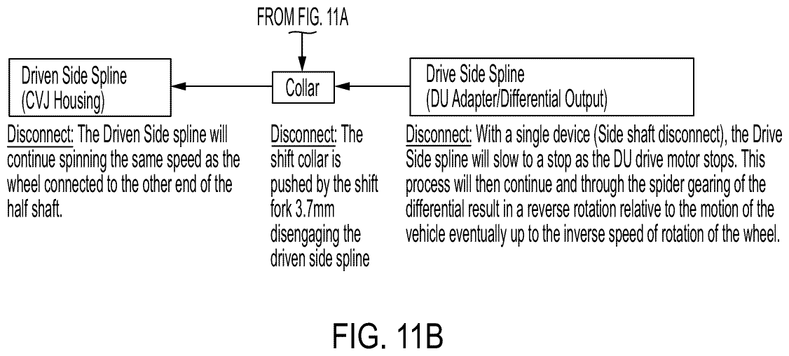

FIGS. 11A-B show functionality of the system from a connected to a disconnected state in accordance with a preferred embodiment.

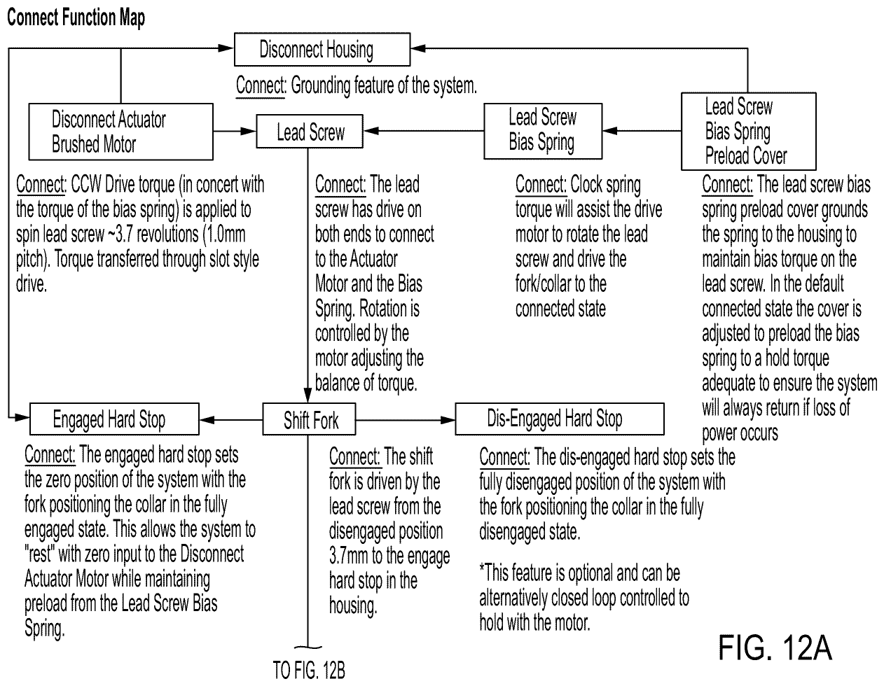

FIGS. 12A-B show functionality of the system from a disconnected to a connected state in accordance with a preferred embodiment.

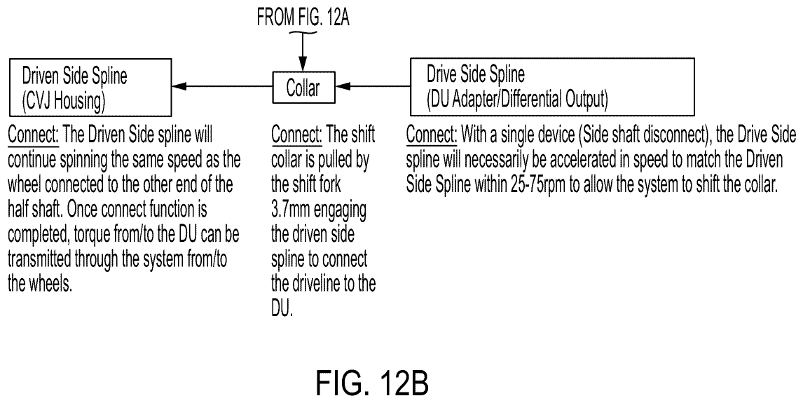

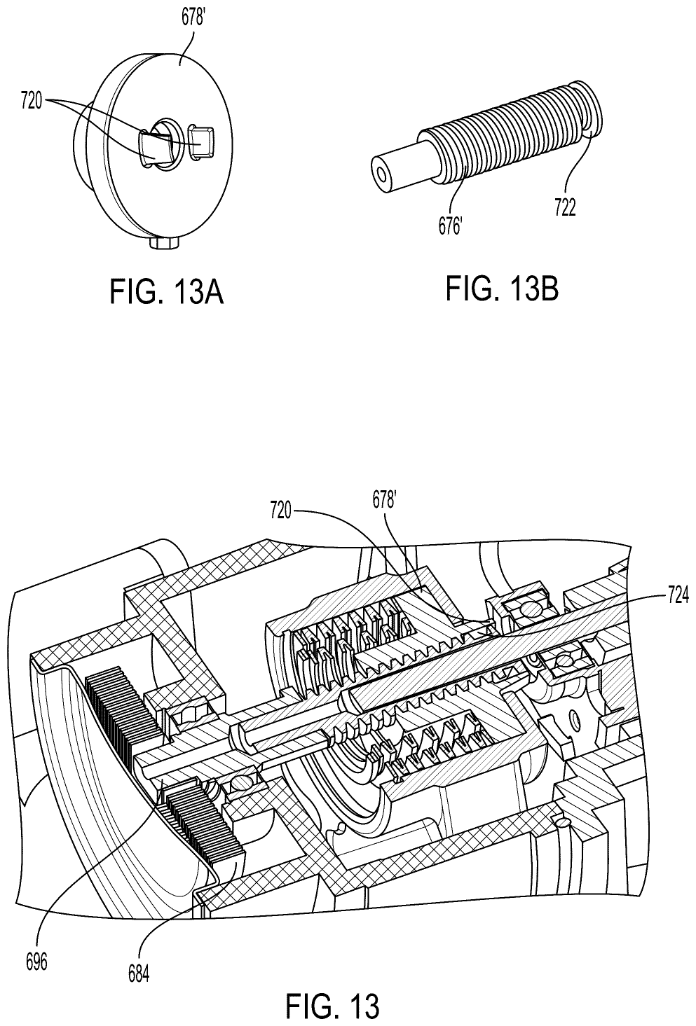

Mechanism 682 can provide bistable functionality. Referring now to FIG. 13, nut portion 678′ includes axially-extending detent fingers 720 that engage with detents defined in a detent ring 722 at the end of lead screw 676′ opposite the adapter 696, together forming a detent arrangement 724. In this embodiment, the spring 684 holds the actuator in the connected state. The detent arrangement 724 holds the actuator in the disconnected state after that actuator fully pulls the nut portion 678′ back towards the actuator motor against the torque of the spring 684. The strength of hold for the detent mechanism 724 should preferably be sufficient to prevent the spring 684 from unseating it in the presence of shock loads and vibration (e.g., vehicle vibration). The hold strength should not be so strong, however, that the actuator motor cannot overcome the lock to disengage it when the system is commanded to move to a connected state. The spring 684 drives the actuator from an in-between state to the connected state.

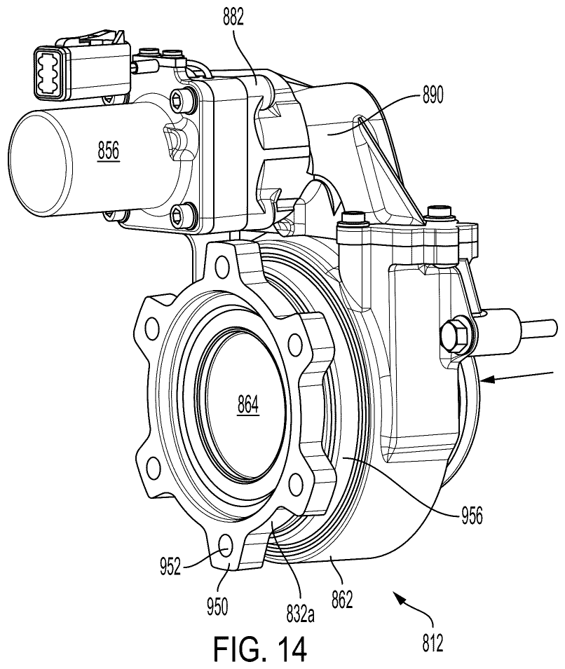

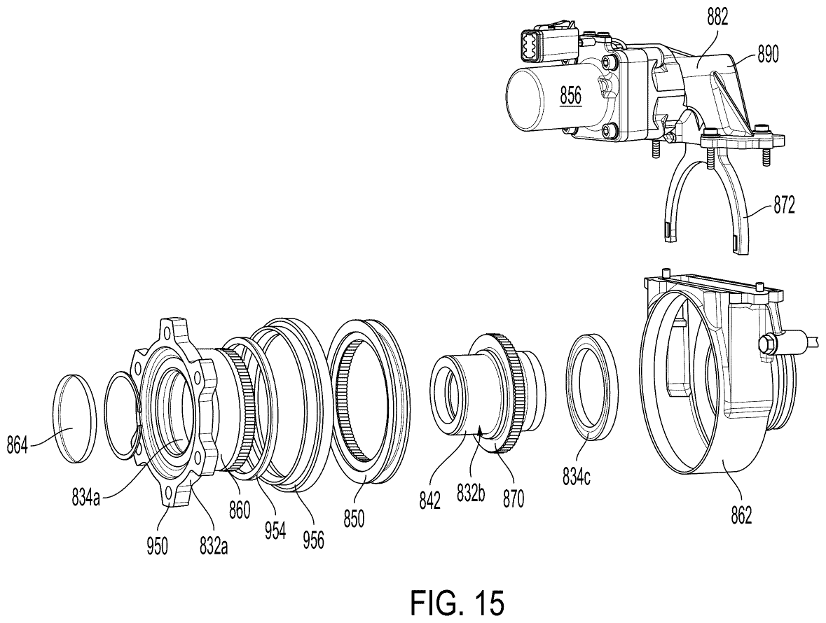

Referring now to FIGS. 14 and 15, it is also desirable to provide a disconnect assembly that is configured to interface with a flange-style CVJ connection. Such a disconnect assembly might be utilized where it is not feasible to integrate the disconnect capability into a half-shaft assembly at the time of manufacture or in certain other CVJ applications (such as a retrofit). The disconnect assembly may be monostable or bistable as described above, continuously stable, or even naturally unstable depending on the exigencies of the application.

Toward this end, FIGS. 14 and 15 illustrate a disconnect assembly 812 constructed in accordance with an embodiment of the present invention. In this case, disconnect assembly provides monostable or bistable functionality similar to CVJ 612 described above. Components of assembly 812 analogous to those of CVJ 612 will be identified by a reference number augmented by two hundred.

Assembly 812 has a first portion 832a which is configured for coupling to the “outer” of a CVJ with which it is to be used (and thus functionally becomes part of the CVJ outer). In this case, first portion 832a includes a series of angularly spaced radial projections 950 defining respective through-bores 952 parallel to the rotational axis. The projections 950 collectively form a flange interface which will be juxtaposed to the flange of the CVJ. In this regard, first portion 832a can be secured to the CVJ flange via elongate fasteners (e.g., bolts) extending through the through bores 952.

The remaining components may be the same as or similar to those described above in relation to FIGS. 7 and 8. In this regard, a second portion 832b is configured to rotate with or rotate independently of first portion 832a depending on whether assembly 812 is in a connected or disconnected state. In this case, second portion 832b is configured as a hub to receive, for example, the stub shaft of a differential or e-drive unit. As shown, portion 832a has an annular extension 860 that is located coaxial to an extension 842 of second portion 832b. A pair of ball bearings, such as bearing 834a, is located in the radial space between extensions 842 and 860. An additional ball bearing 834c may be located between an inward extension of second portion 832b and an environmental housing 862 of the disconnect 812. First portion 832a carries a drum-like wall 864 to enclose the second portion 832b.

Second portion 832b has a radial flange 870 having a series of axial splines on its outer circumference. Disconnect collar 850 has splines on its inner circumference engaged with the outer splines of flange 870. An actuator 856, here in the form of a lead screw actuator, moves a fork 872 axially. Fork 872 engages an annular slot of collar 850 so as to shift collar 850 between connected and disconnected positions. In the connected position, collar 850 engages both of first portion 832a and 832b causing them to rotate together (i.e., there is no relative rotation). In the disconnected position, collar 850 is retracted from second portion 832b. First portion 832a can thus rotate at wheel speed independent of rotation of second portion 832b.

Actuator 856 includes a motor that rotates a lead screw. Disconnect fork 872 includes an integral nut portion that moves axially as the lead screw is rotated. The direction of rotation determines whether the nut portion (and the disconnect fork 872 of which it is a part) moves in forward or reverse directions. Annular members 954 and 956 are secured to first portion 832a and second portion 832b, respectively. Members 954 and 956 are interdigitated to provide a labyrinthine path between the interior of housing 862 and the region outside of housing 862.

While one or more preferred embodiments of the invention are described above, it should be appreciated by those skilled in the art that various modifications and variations can be made in the present invention without departing from the scope and spirit thereof.

What is claimed is:

1. A continuous velocity joint assembly comprising:
a rotatable input and a rotatable output;
a continuous velocity mechanism that allows transfer of power between the input and the output while allowing angular variation;
a disconnect arrangement having first and second portions capable of relative rotation with respect to one another in a disconnected state and incapable of relative rotation with respect to one another in a connected state; and
an electromechanical actuator causing the disconnect arrangement to shift between the disconnected state and the connected state, whereby the power is transferred between the input and the output in the connected state and power is not transferred between the input and the output in the disconnected state.

2. A continuous velocity joint assembly as set forth in claim 1, wherein the electromechanical actuator comprises a screw-type actuator.

3. A continuous velocity joint assembly as set forth in claim 2, wherein the screw-type actuator comprises a lead screw actuator having a lead screw rotatably driven by an electric motor.

4. A continuous velocity joint assembly as set forth in claim 3, further comprising a state-maintaining mechanism operative to maintain the disconnect arrangement in at least one of the connected state and the disconnected state if power to the actuator is lost.

5. A continuous velocity joint assembly as set forth in claim 4, wherein the state-maintaining mechanism comprises a torsion spring operative to rotate the lead screw via energy stored in the torsion spring to move the disconnect arrangement to a selected one of the connected state and the disconnected state if power to the actuator is lost.

6. A continuous velocity joint assembly as set forth in claim 5, wherein the torsion spring comprises a clock spring.

7. A continuous velocity joint assembly as set forth in claim 5, wherein the state-maintaining mechanism is configured to provide a selectable preload to the torsion spring.

8. A continuous velocity joint assembly as set forth in claim 5, further comprising a detent arrangement to maintain the disconnect arrangement in another one of the connected state and the disconnected state if power to the actuator is lost.

9. A continuous velocity joint assembly as set forth in claim 1, wherein the first portion of the disconnect arrangement comprises an outer housing in which a shaft carrying multiple trunnions is received.

10. A continuous velocity joint assembly as set forth in claim 9, wherein the second portion of the disconnect arrangement is located axially adjacent to the outer housing, the disconnect arrangement further comprising a clutching mechanism that selectively connects the first and second portions together in the connected state and disconnects the first and second portions in the disconnected state.

11. A continuous velocity joint assembly as set forth in claim 10, wherein the clutching mechanism comprises a shiftable collar having splines defined on its inner circumference, at least one of the first portion and the second portion having splines on an outer circumference slidably engaged by the splines of the shiftable collar.

12. A continuous velocity joint assembly as set forth in claim 11, wherein the shiftable collar defines an annular groove about its outer circumference engaged by a fork such that the collar can rotate with respect to the fork, but shifting movement of the fork moves the collar axially.

13. A continuous velocity joint assembly as set forth in claim 1, wherein the first portion of the disconnect assembly comprises an annular member attached to a rotatable housing in which a shaft carrying a plurality of trunnions is received.

14. A continuous velocity joint assembly as set forth in claim 13, wherein the annular member has a plurality of radial projections spaced apart about its periphery, each of the radial projections defining an axial through-bore in which an elongate fastener is received.

15. A continuous velocity joint assembly as set forth in claim 1, further comprising a state-maintaining mechanism operative to maintain the disconnect arrangement in at least one of the connected state and the disconnected state if power to the actuator is lost.

16. A disconnect arrangement for use with a continuous velocity joint, the arrangement comprising:
first and second portions capable of relative rotation with respect to one another in a disconnected state and incapable of relative rotation with respect to one another in a connected state;
the first portion configured to be secured to an outer housing of the continuous velocity joint;
the second portion configured to be connected to a source of rotational power; and
an actuator causing the disconnect assembly to shift between the disconnected state and the connected state, whereby power is transferred between the second portion and the first portion in the connected state and power is not transferred between the second portion and the first portion in the disconnected state.

17. A disconnect arrangement as set forth in claim 16, wherein the first portion is configured to be secured to a flange of the outer housing of the continuous velocity joint.

18. A disconnect arrangement as set forth in claim 17, wherein the first portion defines a plurality of angular spaced projections defining respective axial through bores to facilitate securement of the first portion to the flange of the continuous velocity joint.

19. A disconnect arrangement as set forth in claim 16, further comprising a state-maintaining mechanism operative to maintain the disconnect arrangement in at least one of the connected state and the disconnected state if power to the actuator is lost.

20. A disconnect arrangement as set forth in claim 19, wherein the state-maintaining mechanism comprises a torsion spring operative to rotate the lead screw via energy stored in the torsion spring to move the disconnect arrangement to a selected one of the connected state and the disconnected state if power to the actuator is lost.

21. A disconnect arrangement as set forth in claim 20, wherein the torsion spring comprises a clock spring.
